(19) United States
(12) Patent Application Publication
(10) Pub. No.: US 2012/0258264 A1
(43) Pub. Date: Oct. 11, 2012

(54) BIRD REPELLENT APPARATUS

(76) Inventor: MINORU KYODEN, YACHIYO-SHI (JP)

(21) Appl. No.: 13/527,630

(22) Filed: Jun. 20, 2012

(30) Foreign Application Priority Data
Dec. 29, 2010 (JP) 2010-294900

(51) Int. Cl. A01M 29/06

(52) U.S. Cl. 428/16

(57) ABSTRACT

Provided is a bird repellent apparatus which can maintain the invasion prevention effect even on shrewd birds having a learning ability over a long period of time. A projection on the head portion side of an upper edge portion of both wings of a hawk imitating body is 3D-formed in a hawk-like geometry, being made of a rain resistant thin material having a shape of thorns similar to holly leaf ones on the periphery thereof. Hawk imitating body is colored black as a whole, with beak, parietal portion, wing edge portion, eyes, and nails being colored silver; the projection is supported such that it can be rocked in a definite direction by wind, the lower portion of a shaft thereof being located inside the body; and a head portion of hawk imitating body is directed slightly downward of the horizontal line such that the eyes look down.

### FIELD OF TECHNOLOGY

The following relates to a bird repellent apparatus, and more particularly, to a bird repellent apparatus that can be installed in farms, fruit ranches, and the like, for preventing undesirable birds, such as crows, and the like, from coming flying.

### BACKGROUND

The bird repellent apparatus is installed in farms, fruit ranches, parks, and the like, for preventing cereal grains, fruits, and the like, from being eaten away by birds. Conventional bird repellent apparatuses utilize an imitating body of a bird, and utilize an imitating body which causes a snake to be brought to mind, and the like.

However, these bird repellent apparatuses have an aspect which allows shrewd birds to soon detect that the menace animal in the apparatus is merely an imitation, and thus, the apparatuses have presented a problem that, although there is a temporary effect of scaring birds, they cannot continue to prevent invasion of them over a long period of time.

The present disclosure has been made to solve the aforementioned problem of the prior art, and can provide a bird repellent apparatus which can maintain the invasion prevention effect even on shrewd birds having a learning ability over a long period of time.

### SUMMARY

One aspect relates generally to a bird repellent apparatus having a projection on an upper edge portion of both wings of a hawk imitating body, being 3D-formed in a hawk-like geometry, the projection being made of a rain resistant thin material having convexities and concavities on the periphery thereof.

In one embodiment, the hawk imitating body is colored black as a whole, with a beak, a parietal portion, an upper edge portion of both wings, eyes, and nails being colored silver; a head portion of the hawk imitating body is directed slightly downward of the horizontal line such that the eyes look down; and the projection has a geometry similar to that of a holly leaf. In another embodiment, the projection is supported such that it can be rocked in a definite direction, being subjected to the force of a wind, the lower portion thereof being located in the inside of the body.

The bird repellent apparatus according to the present invention is as described above, and with this bird repellent apparatus, a projection made of a thin material having a geometry similar to that of a holly leaf is mounted on the upper edge portion of both wings of the hawk imitating body, and this projection is rocked, being subjected to the force of a wind, the appearance being unfamiliar to a bird, giving a sensation of fear. Accordingly, if this bird repellent apparatus is disposed in a farm, a fruit ranch, a park, a private house, or the like, the bird repellent effect thereof will be continued to be exerted over a long period of time.

### BRIEF DESCRIPTION OF THE DRAWINGS

Some of the embodiments will be described in detail, with reference to the following figures, wherein like designations denote like members, wherein:

FIG. 1 is a perspective view of a bird repellent apparatus in one embodiment;

FIG. 2(A) and FIG. 2(B) are perspective views illustrating the configuration of a hawk imitating body (a head portion and a wing portion thereof) of the bird repellent apparatus;

FIG. 3(A) and FIG. 3(B) are drawings illustrating an example of geometry of projections of the bird repellent apparatus; and

FIG. 4 is a drawing illustrating an example of way of supporting the projection in the bird repellent apparatus.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. As a preface to the detailed description, it should be noted that, as used in this specification and the appended claims, the singular forms “a”, “an” and “the” include plural referents, unless the context clearly dictates otherwise.

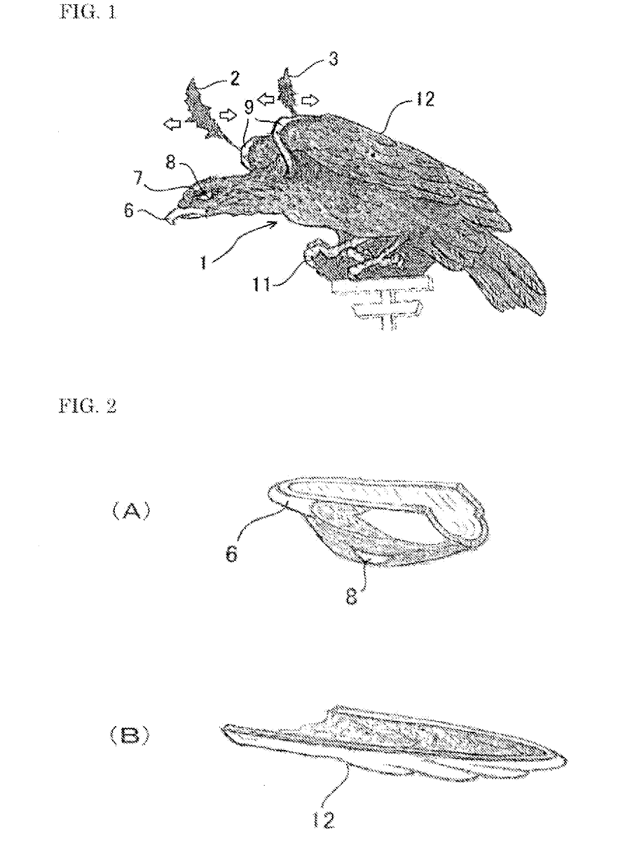

FIG. 1 is a perspective view of a bird repellent apparatus in one embodiment, and in the figure, reference numeral 1 denotes a hawk imitating body which imitates the geometry of a hawk, and generally, the hawk imitating body 1 is 3D-formed to a size which is slightly larger than the life size of a normal hawk. The hawk imitating body 1 is formed by jointing molded halves (see FIG. 2(A) and 2(B)) thereof into one integral. Preferably, in order to threaten a bird as an object, the entire body thereof is colored black, a beak 6, a parietal portion 7, an eye 8, both wing edge portions 9, and a nail 11 being provided with a different color, i.e., silver (by coloring, applying a silver-coated paper, or using any other method). In addition, as shown in FIG. 1, it is preferable that a head portion of the hawk imitating body 1 be directed slightly downward of the horizontal line such that the eyes look down.

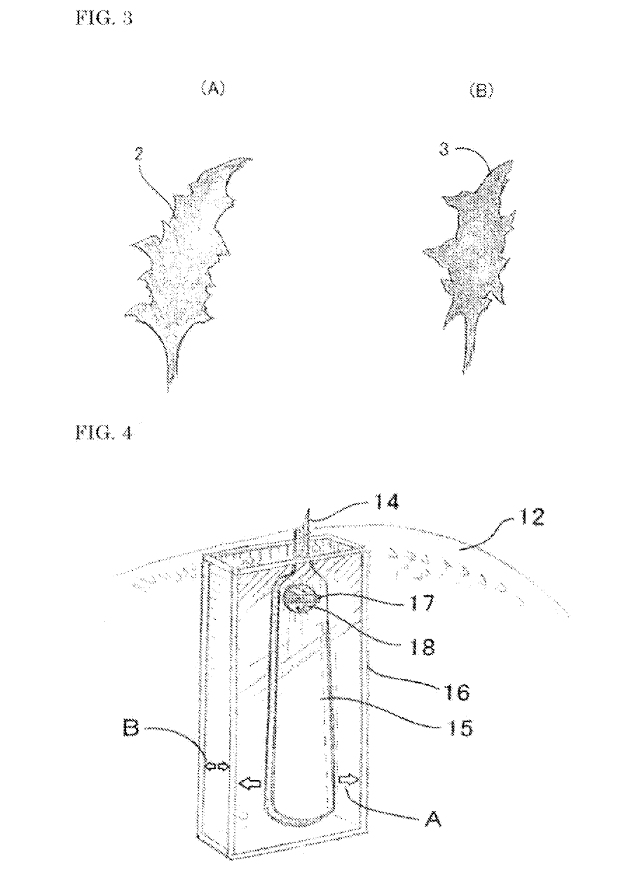

The bird repellent apparatus may feature that, on the head portion side of an upper edge portion of a wing portion 12 of the hawk imitating body 1, there is mounted a projection 2, 3 (see FIG. 3(A) and 3(B)) which can give a sensation of fear, having a geometry unfamiliar to a bird, for example, a shape having convexities and concavities (thorns) similar to those of a holly leaf on the periphery. The projection 2, 3 is made of a rain resistant thin material, such as a resin, or the like, being mounted on the head portion side of the upper edge portion of the wing portion 12. In FIG. 3(A) and 3(B), which are given as an example, the projection 2 is formed slightly larger than the projection 3.

For example, the projection 2, 3 is supported such that it can be rocked in a definite direction by wind, the lower portion of the shaft thereof being located in the inside of the body. FIG. 4 gives an example of configuration for doing this, and as shown in the same figure, a lower portion 14 of the projection 2, 3 is extended to be communicated with a plate material 15. The plate material 15 is rockably pivoted in a casing 16 disposed in the inside of the wing portion 12 of the hawk imitating body 1, which is designed to be hollow. The pivoting feature is provided by freely fitting a pivot 17, being disposed in the upper portion of the casing 16, into a supporting hole 18, which is formed in the upper portion of the plate material 15. With this configuration, the projection 2, 3 can be rocked in a horizontal direction A of the casing 16 in the course of a pendulum motion of the plate material 15, or in a direction B, which is orthogonal to the direction A, depending upon the direction of the wind.

The bird repellent apparatus can be used not only in the farm which can be subjected to damage by birds, but also in various facilities related to agricultural products and livestock products, or in general residences for avoiding bird damages.

By the way, the private house of the present inventor is located in the back street of the restaurant street in a shopping center, where a number of crows and sparrows gather to peck at garbage in collection bags. In the balcony of the third floor of the present inventor's private house, there is a fire thorn as high as 2 meters, which produces a lot of fruits every year. Because crows and other birds came flying, aiming at the fruits, the present inventor placed a commercially available bird imitation, but there was practically no efficacy. Then, the present inventor placed a hawk imitating body 1 having a projection 2, 3, then crows came flying, but turned about to fly away, as soon as they looked at the hawk imitating body 1, and thereafter the fire thorn has been subjected to no damage by crows.

The reason why the bird repellent apparatus exerted such a great effect is nothing else but the geometry and movement of the projection 2, 3 were unfamiliar to the crows, giving a sensation of fear, and the threatening effect was increased by a synergistic action of the features of the bird repellent apparatus that the hawk imitating body has a geometry similar to that of a hawk scaring crows, sparrows, and the like, that preferably the hawk imitating body is colored black as a whole, with the beak, the parietal portion, both wing edge portions, the eyes, and the nails being colored silver, and that the head portion of the hawk imitating body is directed slightly downward of the horizontal line, the eyes looking down as if they showed an aggressive posture.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. A bird repellent apparatus comprising:
a projection on an upper edge portion of both wings of a hawk imitating body, the hawk imitating body being 3D-formed in a hawk-like geometry;
wherein the projection is made of a rain resistant thin material having a shape of thorns similar to those of a holly leaf on a periphery thereof.

2. The bird repellent apparatus of claim 1, wherein the hawk imitating body is colored black as a whole, with a beak, a parietal portion, an upper edge portion of both wings, eyes, and nails being colored silver.

3. The bird repellent apparatus of claim 1, wherein a head portion of the hawk imitating body is directed slightly downward of a horizontal line such that the eyes look down.

4. The bird repellent apparatus claim 1, wherein the projection has a geometry similar to that of a holly leaf.

5. The bird repellent apparatus of claim 1, wherein the projection is supported such that it can be rocked in a definite direction, being subjected to a force of a wind, the lower portion thereof being located in an inside of the body.
